(19) United States
(12) Patent Application Publication
(10) Pub. No.: US 2005/0217806 A1
(43) Pub. Date: Oct. 6, 2005

(54) Mechanism for manoeuvring a door, use of a brake in such a mechanism, and method for regulating a diving torque in such a mechanism

(75) Inventors: Serge Bruno, Marnaz (FR); Sergyl Clerget, Bluffy (FR); Daniel Depaix, Cluses (FR)

Correspondence Address: Ralph A. Dowell;Dowell & Dowell, P.C., Suite 406, 2111 Eisenhower Ave, Alexandria, VA, 22314, US

(73) Assignee: Somfy SAS

(21) Appl. No.: 11/091,543

(22) Filed: Mar. 29, 2005

(30) Foreign Application Priority Data
Mar. 31, 2004 (FR) 04 03383

(51) Int. Cl. E05F 15/00

(52) U.S. Cl. 160/189

(57) ABSTRACT

The mechanism according to the invention comprises an electric motor, a member adapted to be driven by the motor and kinematically linked with the door, and means for compensating at least partially the torque exerted by the weight of the door on this member. A brake interposed between the motor and the aforementioned member exerts against the motor a braking effort at least in the phases of displacement of the door where the combined effect of the weight of the door and of the effort exerted by the compensation means tends to displace this member in the same direction as the motor. The brake makes it possible to limit the variations of the torque to be exerted by the motor.

### FIELD OF THE INVENTION

The present invention relates to a mechanism for manoeuvring a door whose movement is partially vertical. The invention also relates to the use of a brake in such a mechanism, as well as to a method for regulating the torque exerted by a motor in such a mechanism.

Within the meaning of the present invention, the term “door” is understood to mean doors, portals, shutters, grilles and equivalent equipment for selectively closing an opening in a building.

### BACKGROUND OF THE INVENTION

Doors whose movement is partially vertical are sometimes referred to as “doors stored substantially horizontally” and are conventionally used for selectively closing an opening, for example giving access to a garage. These doors are globally vertical in closed configuration and globally horizontal, generally disposed near the ceiling, in open configuration. Their movement of opening/closure therefore has both a horizontal component and a vertical component. For manoeuvring doors of this type, it is known to use a geared motor comprising an electric motor and a reduction gear.

For certain doors, and particularly garage doors, it is furthermore known from WO-A-03/083245 to use so-called “compensation” means, such as springs, aiming at compensating at least partially the weight of a door. Such compensation means aim at reducing the driving force necessary for manoeuvring the door, particularly when the latter is raised. The compensation means are generally designed so that the variations of the combined effect of the effort of compensation and of the weight of the door are as slight as possible. Nevertheless, however improved they may be, these means do not enable a perfect result to be attained and, in practice, the door is generally over-compensated, in which case it tends to rise despite its weight, or under-compensated, in which case it tends to descend under the effect of its weight. The over- or under-compensated nature of the door may vary as a function of the position of the door in the course of its displacement, insofar as the resultant torque of its weight depends on its position with respect to the lintel of the opening. For example, on certain tip-up doors of non-projecting type, the compensation means most often ensure a balance of the weight of the door when the latter is in median position but, in the vicinity of its closed position or its completely open position, the door may be driving then, beyond the median point, become braking. On other types of doors, for example sectional doors, the over- or under-compensated nature of the door may undergo several alternations. In addition, these variations may be a function of the wear and tear of the door and/or of its guiding means.

The over- or under-compensated nature of the door may provoke disorders during its displacements, particularly since its speed varies as a function of the nature of the compensation and this, all the more so as the inertia of the door and the passage from a situation of over-compensation to a situation of under-compensation, or vice versa, amplifies the accelerations. The movement of the doors is therefore sometimes jerky, with bouncing effects. This induces functioning of the electric drive motor at irregular speed and, in particular, the fact that it sometimes functions as generator, which may substantially limit its life duration. In addition, when it functions as generator, a motor may emit a sound of frequency unpleasant for a person located in the vicinity.

The aforementioned drawbacks are a source of visual and sound nuisance for a user and induce additional stresses on the door and its manoeuvring system. In particular, the motor and its electrical supply system risk being deteriorated due to the current peaks resulting from the motor functioning as generator.

In order to solve this problem, it is known to render the transmission of the movement between the door and the motor irreversible, for example by means of a reduction gear comprising a wheel and an endless screw. Such an irreversible reduction gear is of relatively mediocre efficiency, which imposes using a motor of higher power than really necessary, consuming more energy, which is more cumbersome and more expensive to buy and to use. In addition, such an irreversible reduction gear must be dimensioned to absorb jerks and the wear and tear due to frictions in the kinematic chain.

It is a more particular object of the invention to overcome these drawbacks by proposing a manoeuvring mechanism equipped, inter alia, with means for compensating the weight of a door thanks to which a smooth displacement of the door may be obtained, without using an irreversible reduction gear and by means of a motor whose dimensioning can be optimized.

### SUMMARY OF THE INVENTION

In this spirit, the invention relates to a mechanism for manoeuvring a door with at least partially vertical movement, this mechanism comprising:
an electric motor;
a member adapted to be driven by the motor and kinematically linked with the door; and
means for compensating at least partially the torque exerted by the weight of the door on this member,
   characterized in that it comprises a brake interposed between this motor and this member, this brake being adapted to exert against the motor a braking effort at least in the phases of displacement of the door where the combined effect of the weight of the door and of the effort exerted by the compensation means tends to displace this member in the same direction as the motor.

Thanks to the invention, the brake makes it possible to regulate the torque that the electric motor must exert in order to drive the door, regulation taking place as a function of the torque that the motor must effectively overcome, this torque to be overcome itself being substantially equal to the combined effect, i.e. to the resultant, of the torque exerted by the compensation means and the torque exerted by the weight of the door. The invention therefore proceeds from an original approach which consists in braking the movement of the door more or less, as a function of the combined effect of the compensation means and of the weight of the door. More precisely, braking takes place at least when the door is driving with respect to the direction of the movement imparted by the motor. The braking effort is advantageously variable as a function of the intensity and direction of the combined effect of the weight of the door and of the compensation effort exerted by the aforementioned means.

According to advantageous but non-obligatory aspects, a manoeuvring mechanism may incorporate one or more of the following characteristics:
The braking effort exerted by the brake is maximum, when the aforementioned combined effect tends to displace the aforementioned member in the same direction as the motor.
The braking effort exerted by the brake is decreasing as a function of the aforementioned combined effect when this effect tends to displace the member in the opposite direction to the motor. The braking effort is in that case preferably substantially inversely proportional to this combined effect.
The maximum value of the torque exerted by the brake is substantially equal to the nominal torque of the motor. In this way, the torque exerted by the motor varies little and the speed of displacement of the door is virtually constant over its stroke.
The motor is of D.C. type, with a regulated voltage supply. Thanks to this aspect of the invention, the torque exerted by the brake may be reduced, this making it possible to optimize the dimensions of the motor while conserving, on the zone of negative compensation, a slight variation of the driving torque. This enables a regular displacement of the door to be maintained.
The brake is of friction type, with at least one mobile lining as a function of the value and/or the direction of the aforementioned combined effect.
The brake is controlled in order to exert the braking effort as a function of the output signal of a sensor detecting the direction and/or the value of the aforementioned combined effect.

The invention also relates to the use of a brake in a mechanism as described hereinabove and, more specifically, to the use of a brake adapted to exert a variable effort for regulating the torque that must be exerted by an electric motor for driving a member fast with a door with partially vertical movement subjected to the action of means for at least partially compensating its weight.

The invention also relates to a method for regulating the torque to be exerted by an electric motor in a mechanism as described hereinabove, this method comprising at least one step in which a braking effort is exerted, against the motor, as a function of the intensity and the direction of the combined effect of the weight of the door and of the effort of compensation of this weight.

This effort is exerted at least when the aforementioned combined effect tends to displace the aforementioned member in the same direction as the motor.

Thanks to the method of the invention, the brake compensates more or less the combined effect or resultant torque, this allowing an optimization of the torque to be exerted by the electric motor, the amplitude of variation of this torque being able to be relatively minor compared to the amplitude of the torque to be exerted in the known equipment.

The blocking torque of the brake may be exerted with a maximum value, when the aforementioned combined effect is of the same direction as the torque exerted by the motor, and a decreasing value, preferably inversely proportional to this combined effect, when this effect tends to displace this member in the opposite direction to the motor.

### BRIEF DESCRIPTION OF THE DRAWINGS

The invention will be more readily understood and other advantages thereof will be more clearly apparent in the light of the following description of two forms of embodiment of a mechanism in accordance with its principle, and of a torque regulating method-carried out thanks to this mechanism, given solely by way of example and made with reference to the accompanying drawings, in which:

FIG. 1 is a side view of a garage door equipped with a mechanism according to the invention.

FIG. 2 is a plan view from above of the door of FIG. 1.

FIG. 3 is an axial section, on a larger scale, along line III-III in FIG. 2, in a first configuration.

FIG. 4 is a view on a larger scale of detail IV in FIG. 3, while the mechanism is in a second configuration.

FIGS. 5A and 5B are schematic developed representations of certain kinematic elements of the mechanism of FIGS. 1 to 4, respectively in the configurations of FIGS. 4 and 3.

FIG. 6 is a graph representing certain efforts produced in the mechanism of FIGS. 1 to 5.

FIG. 7 is a schematic representation allowing the evolution of certain speeds of displacement as a function of the applied torques to be assessed.

FIG. 8 is a section similar to FIG. 3 for a mechanism in accordance with a second form of embodiment of the invention, and

FIG. 9 is a section in plane XI-XI in FIG. 8.

### DESCRIPTION OF PREFERRED EMBODIMENTS

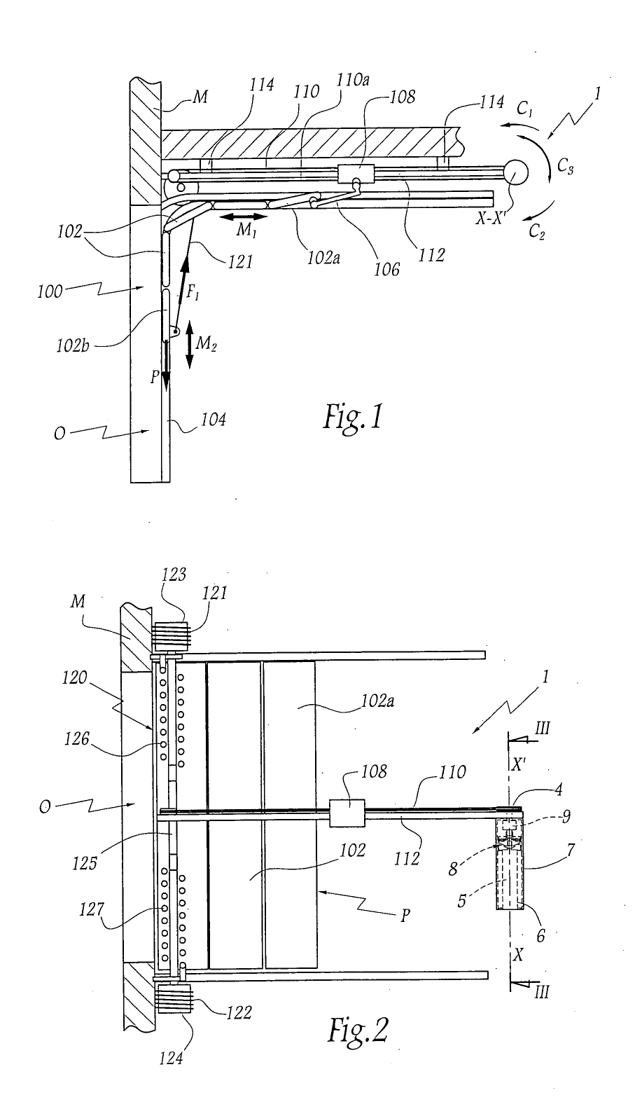

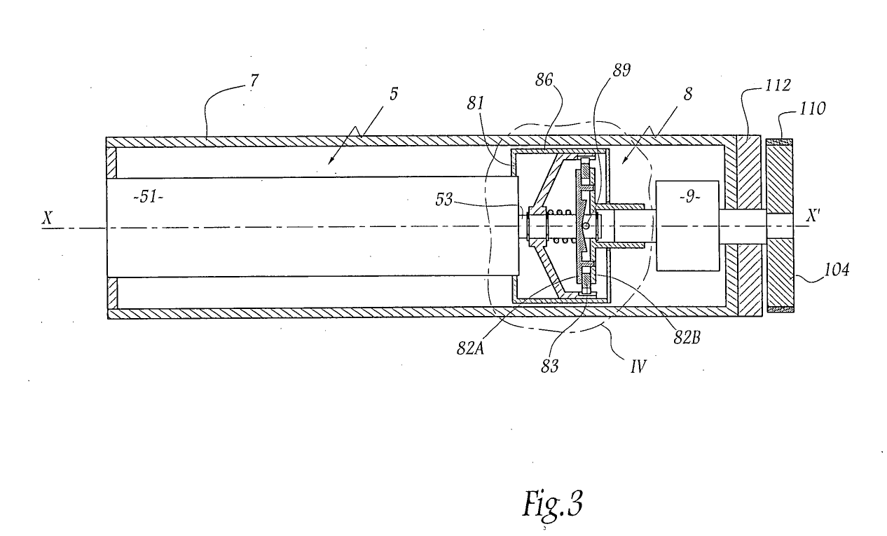

Referring now to the drawings, the installation shown partially in FIGS. 1 to 5 comprises a mechanism 1 for displacing a garage door 100 between a closed position, where this door is vertical and obturates an opening O, and an open position, where this door is globally horizontal. The door 100 is sectional and constituted by a plurality of panels 102 articulated on one another and provided with rollers adapted to roll in guides 104 provided on either side of the opening O. The upper panel 102a of the door 102 is connected by a tie bar 106 to a carriage 108 displaced perpendicularly to the wall M in which the opening O is made, by an endless belt 110 driven by the mechanism 1. The carriage is fast with the lower side of the belt 110 and slides along a bar 112 fixed parallel to the ceiling of the garage by two brackets 114.

The door 100 is provided to move in a movement having a horizontal component M₁, globally parallel to the direction of the ceiling of the garage, and with a vertical component M₂, globally parallel to the wall in which the opening O is made.

In order to drive the belt 110, a ring 4 is provided to move in rotation about a substantially horizontal axis X-X′, the belt 110 surrounding the ring 4 over about 180° and being fast in rotation therewith by adherence or thanks to notches.

For driving the ring 4 about the axis X-X′, an electric motor 5 is provided, mounted at one end of the bar 112 and housed inside a tube 7.

A device 120 for compensating the weight of the door 100 is provided and comprises two cables 121 and 122 fixed on the lower panel 102b of the door 100 and each wound on a drum 123, 124 respectively. The drums are connected by a synchronisation bar 125 surrounded by two compensation springs 126 and 127 of which one end is fixed on the bar and the other end is fixed to the structure. In this way, as a function of the displacement of the door 100, the springs 126 and 127 are more or less stretched and contribute to exerting on the door 100 and through the cables 121 and 122 an effort F₁ which opposes the weight P of the door 100.

The output shaft 53 of the motor 5 actuates a friction brake 8 at the output of which is mounted a reversible reduction gear 9 which itself actuates the ring 4.

In this way, the movement of the output shaft of the motor 5 may be transmitted to the ring 4 through the brake 8 and the reduction gear 9.

The brake 8 is in accordance with the technical teaching of FR-A-2 834 391 and comprises a casing 81 fixed on the casing 51 of the motor 5 and which contains two discs 82A and 82B between which is disposed an annular ring 83 in mesh by outer radial projections 84 with inner radial projections 85 made in a support 86 fixed inside the casing 81 and mounted free in rotation and fixed in translation on the shaft 53. A spring 87 is interposed between the disc 82A and a circlips 88 for immobilizing the support 86 on the shaft 53. It exerts an effort F₈₇ tending to apply the disc 82A and the ring 83 on the disc 82B, which induces a braking torque C₈ in rotation of the disc 82B and of the sleeve 82C in one piece with this disc and in which the input shaft 91 of the reduction gear 9 comes into mesh. The torque C₈ depends on the effort F₈₇ and on the coefficient of friction between the ring 83 and the discs 82A and 82B. By default, the effort F₈₇ exerts a maximum braking torque C₈ₘₐₓ which blocks the ring 83 between the discs 82A and 82B and thus immobilizes the disc 82B with respect to the casing 81 which is fixed. In this way, by default, the brake 8 opposes the transmission of effort between the motor 5 and the reduction gear 9 and between the reduction gear 9 and the motor 5.

A pin 89 is mounted along a diameter of the shaft 53 in the vicinity of its end on which the disc 82B is immobilized in translation by a circlips 82D.

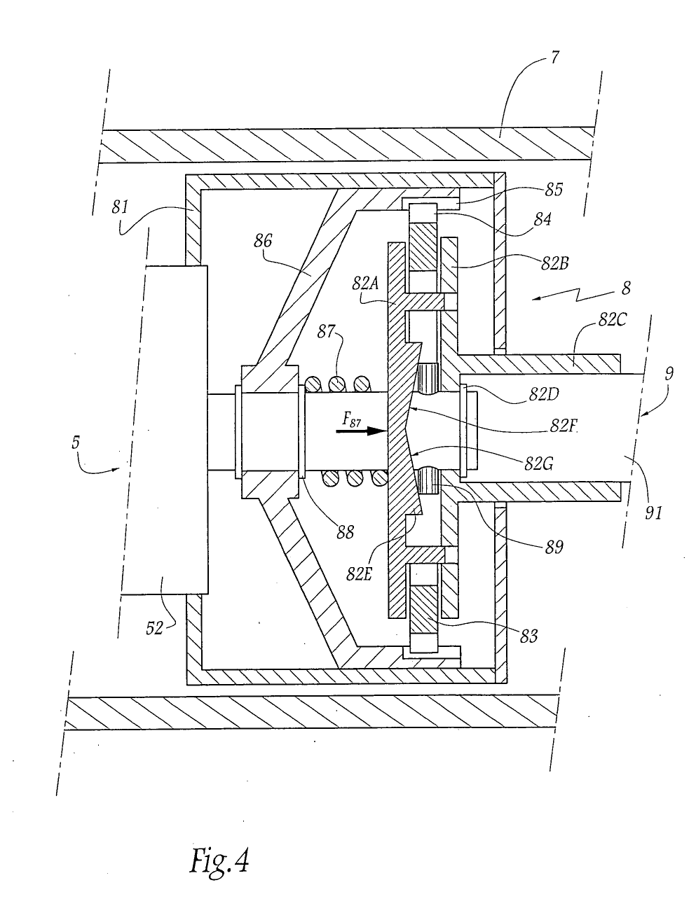

The disc 82A is provided with an excess thickness 82E forming a double ramp 82F, 82G against which the pin 89 bears, as represented in FIG. 2, when the motor 5 drives the shaft 53. This has the effect of axially offsetting the disc 82A in the direction of the circlips 88, against the braking effort F₈₇, thus allowing a movement of slide of the disc 82A with respect to the ring 83 and of the ring 83 with respect to the disc 82B due to the decrease of the value of the torque C₈. In this way, in the configuration of FIG. 4, the brake no longer blocks the transmission of movement of the motor 5 towards the reduction gear 9.

The torque C₅ exerted by the motor for driving the elements 9, 10 and 4 must overcome the braking torque C₈ exerted by the brake 8.

By its construction, the brake 8, which is interposed between the motor 5 and the reduction gear 9, makes it possible to exert a variable braking torque C₈ as a function of the direction and intensity of the torque C₃ undergone by the ring 4 due to the weight P of the door 100, on the one hand, and the effort F₁ of compensation of this weight exerted by the spring 7, on the other hand.

The effort F₁ is transmitted by the door 100 and the elements 106, 108 and 110 to the ring 4 on which it is exerted in the form of a torque C₁ directed in anti-clockwise direction in FIG. 1. The weight P is also transmitted to the ring 4 on which it is exerted in the form of a torque C₂ directed in clockwise direction, as shown in FIG. 1. The combined effect of the weight and the compensation effort is therefore translated, at the level of the ring 4, as a resultant torque C₃ which may be clockwise or anti-clockwise depending on the relative values of the torques C, and C₂.

When the door is raised, when the torque C₁ has an intensity less than torque C₂, it may be considered that the torque C₃ exerted on the ring 4 by the belt 110 is positive, i.e. the compensation due to the springs 126 and 127 is not sufficient to balance the weight of the door 100. The door is in that case braking for the displacement and one might speak of under-compensation or of negative compensation. On the contrary, when the torque C₁ has an intensity greater than the torque C₂, it may be considered that the load, i.e. the door 100 and the elements which are linked thereto, is driving. In other words, the compensation torque C₁ does more than compensate the weight of the door 100. One might speak of over-compensation or of positive compensation. In that case, the torque C₃ may be considered as being negative.

When the door is lowered, the door is braking when the torque C₁ has a value greater than the torque C₂, and driving in the contrary case. The torque C₃ then takes positive and negative values, respectively.

In practice, as a function of the variations of position and of direction of displacement of the door 100 with respect to the opening O, the torque C₃ may vary between a maximum positive value C₃ₘₐₓ and a minimum negative value C₃ₘᵢₙ. Z₁ denotes the range of variation of the torque C₃ between the values C₃ₘᵢₙ and C₃ₘₐₓ. Z₂ denotes the range of positive variation of the torque C₃ and Z₃ the range of negative variation of that torque.

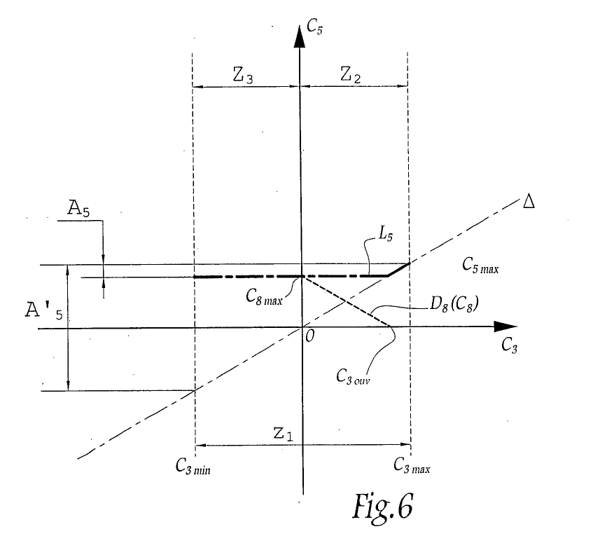

In the absence of a brake such as brake 8, the torque C₅ that the motor 5 would have to exert to drive the ring 4 would, as a function of the torque C₃, be globally such as represented by the straight line Δ in FIG. 6, i.e. a torque substantially balancing the torque C₃.

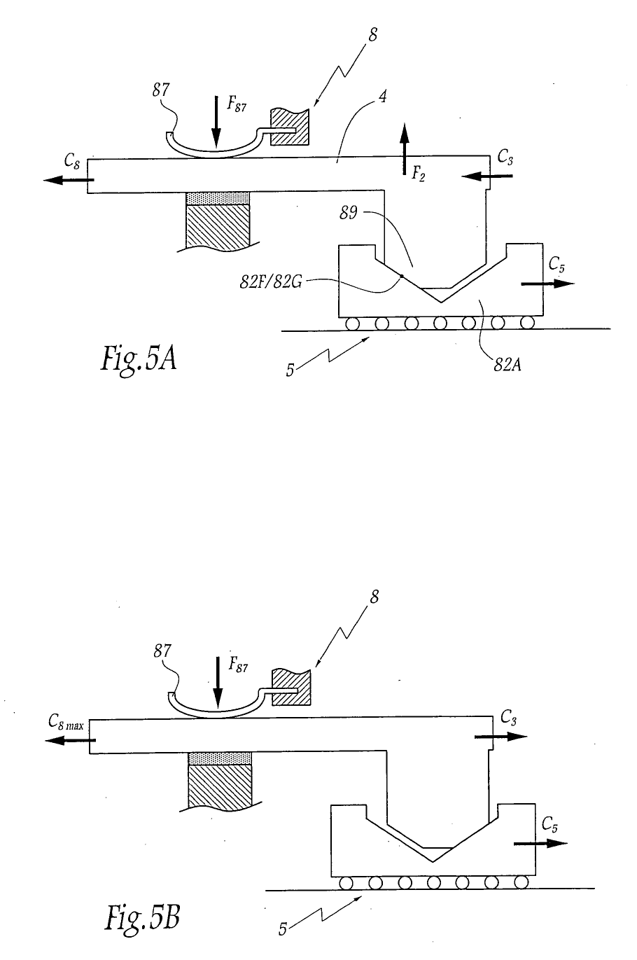

As is more particularly visible in FIG. 5A, when the load is braking, i.e. when one is in the zone Z₂ in FIG. 6, the torque C₅ exerted by the motor may be considered as tending to displace the disc 82A towards the right in FIG. 5A, while the resultant torque C₃ tends to displace the load, i.e. the door 100 and, inter alia, the ring 4, towards the left in this Figure. This results in a transmission of effort at the level of the ramps 82F and 82G and of the pin 89 which induces a displacement F₂ represented directed upwards in FIG. 5A, this displacement tending to detach the linings of the brake 8, against the elastic effort F₈₇. In that case, the torque C₈ decreases when the value of the torque C₃ increases.

On the contrary, and as is apparent in FIG. 5B, if the load is driving, the torque C₃ may be considered as directed towards the right in this Figure and nothing opposes the full effect of the effort F₈₇, with the result that the brake 8 completely brakes the load and exerts a maximum and substantially constant effort C₈ₘₐₓ, which opposes a transmission of effort, particularly of the ring 4 in the direction of the motor 5. The torque C₅ that the motor 5 must exert in order then to drive the door 100 must overcome the braking effort, i.e. C₈ₘₐₓ.

In the configuration of FIG. 5A, the opening torque of the brake 8 is represented by the segment of straight line D₈ in FIG. 6 and it is added to the torque represented by the straight line Δ in the zone Z₂. The resistant torque C₈ generated by the brake is decreasing as a function of the value of C₃ from its nominal and maximum value C₈ₘₐₓ, corresponding to the case of the load being balanced, i.e. when the compensation is neither positive nor negative, towards a zero value corresponding to a value C₃ₒᵤᵥ of the torque C₃ inducing the opening of the brake 8. In fact, in this operational range, the torque C₈ is substantially inversely proportional to the torque C₃.

In zone Z₂, the effort C₅ that the motor 5 must exert in order to displace the ring 4 may therefore be considered as represented by the curve in bold dashed and dotted lines L₅ which is the sum of the straight lines Δ and D₈.

In zone Z₃, the torque that the motor must overcome in order to drive the ring 4 is, as explained with reference to FIG. 5B, equal to the nominal torque C₈ₘₐₓ due to the effort F₈₇. This is why, in this range, the curve L₅ is a horizontal straight line, the torque C₅ to be exerted by the motor being substantially constant and equal to C₈ₘₐₓ.

It follows from the foregoing that, when the motor is supplied, the brake 8 acts more as speed regulator than really as brake in order to block the load.

With the foregoing in mind, the amplitude A₅ of variation of the torque C₅ of the motor 5 is included between the substantially constant value equal to C₈ₘₐₓ of the torque C₅ in the zone Z₃ and over a part of the zone Z₂, and the maximum value C₅ₘₐₓ of this torque for a maximum driving load C₃ₘₐₓ. This amplitude A₅ is largely lower than the corresponding amplitude A′₅ which would have to be taken into account for a mechanism not comprising a brake.

The invention therefore enables the amplitude of the variations of the torque C₅ that the motor 5 must exert to be very substantially decreased. This torque always has a positive value, this excluding, de facto, the functioning of the motor as generator, which functioning would risk deteriorating the motor.

It is possible to distinguish the friction torque of the brake C₈ₘₐₓ, which is that corresponding to a slipping of the brake when there is no load, and the opening torque of the brake C₃ₒᵤᵥ, which is that exerted on the brake at the instant when the linings of the brake separate. The friction torque of the brake corresponds to the value of the torque C₅ that the motor must exert in zone Z₃.

The friction torque C₈ₘₐₓ of the brake 8 is advantageously chosen with a value substantially equal to the nominal torque of the motor, this making it possible to further minimize the variations of the torque and, consequently, the variations of the speed of the door in the course of its displacement.

Thanks to the invention, the speed of displacement of the door is more regular than in the known devices and the jerks and bouncing are avoided. The motor no longer working as a generator, the electrical risks are reduced. In particular, if the motor is an asynchronous motor, there is no risk of the motor stalling.

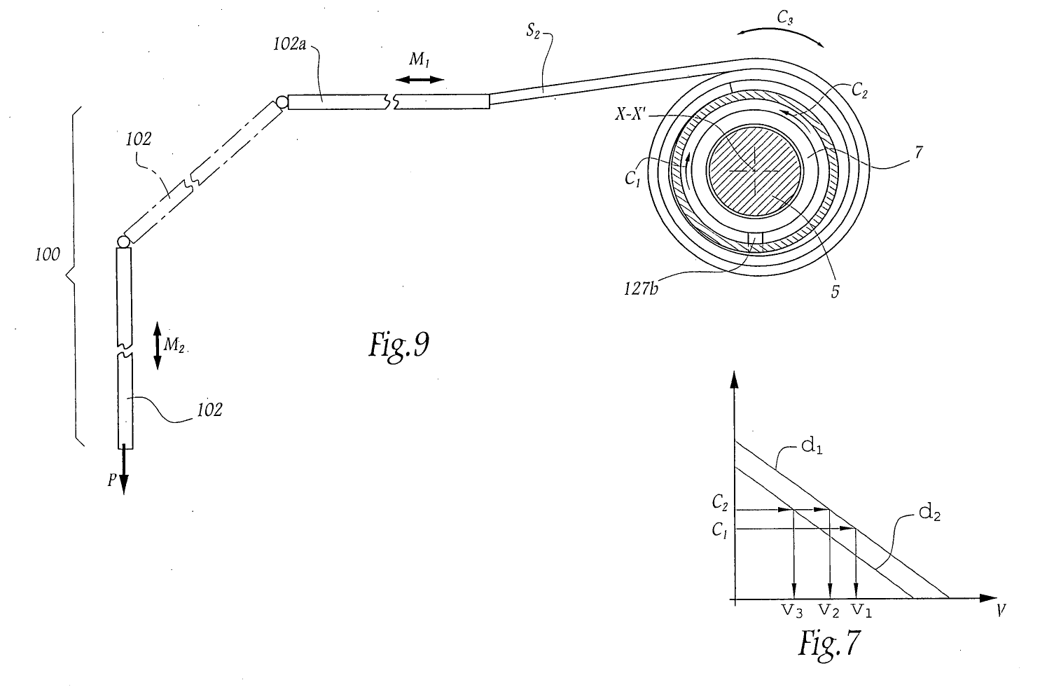

If the motor is a D.C. motor, a simpler and less expensive supply may be used, in particular a so-called “irreversible” supply and/or one regulated in voltage. A so-called “irreversible” supply is more reliable and more economical than a so-called “reversible” supply which must be able to withstand inverse currents coming from the motor. In addition, a voltage-regulated supply makes it possible to fix the relation between the speed of rotation of the motor and the torque exerted, for example in a relation of inverse proportionality as represented in FIG. 7. Such a supply makes it possible to reduce the friction torque of the brake and to optimize the dimensions of the motor while conserving, on the zone of negative compensation Z₂, a slight variation of the driving torque. A regular displacement of the door is therefore obtained, with a motor which is smaller and of lower power than in the known devices. In addition, the installation is rendered reliable.

As is more particularly apparent from FIG. 7, a voltage-regulated supply of a D.C. motor makes it possible to conserve a predetermined relation between values of speed v₁ and v₂ of displacement of the door and values of torque c₁ and c₂. In effect, the corresponding pairs of values v₁, c₁ and v₂, c₂ must lie on a predetermined straight line d₁ in FIG. 7. In the event of passage of the torque from a value c₁ to a value c₂, the speed passes from a value v₁ to v₂ without risk of the speed decreasing to a value v₃ corresponding to the case of the corresponding point being located on a different straight line d₂ in FIG. 7, which might be the case for a non-regulated supply. In this way, the speed variations, from v₁ to v₂, are slighter in the case of a regulated supply than in the case of a non-regulated supply from v₁ to v₃.

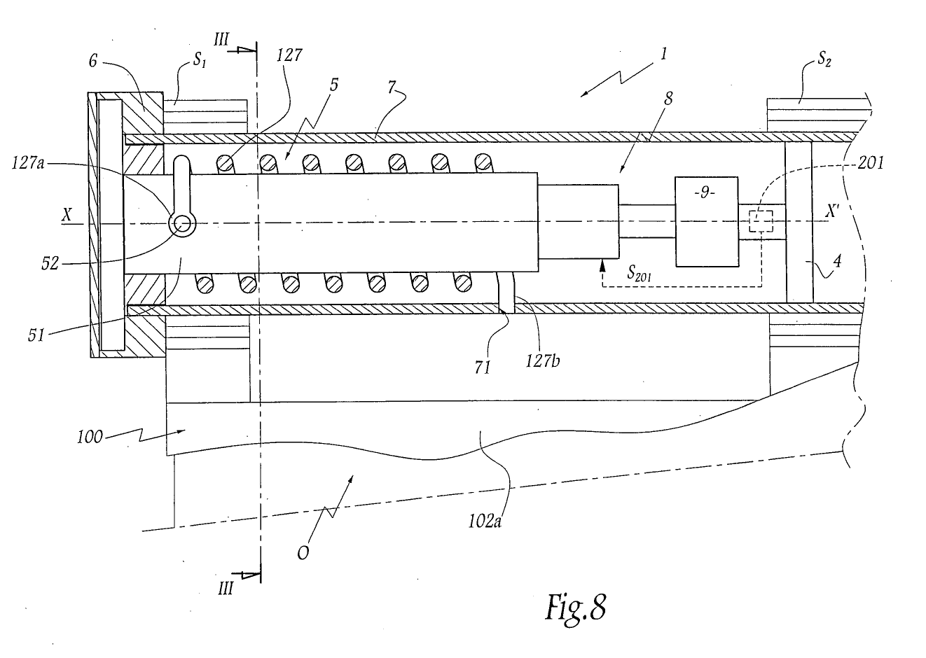

In the second form of embodiment of the invention shown in FIGS. 8 and 9, elements similar to those of the first embodiment bear identical references. This mechanism 1 differs from the preceding one in that the motor 5 is mounted on a bracket 6 fixed to the masonry of the building, this motor being housed inside a tube 7 which it drives in rotation about axis X-X′ by means of the ring 4. Straps S₁ and S₂ are more or less wound around the tube 7, as a function of its position in rotation about axis X-X′, these straps being fixed on the upper panel 102a of the door 100. A compensation spring 127 is mounted inside the tube 7, around the casing 51 of the motor 5. A first end 127a of the spring 127 surrounds a catch 52 provided on the casing 51, while its second end 127b is fixed to the tube 7 by any appropriate means, particularly by introduction in an orifice 71 made in this tube. In this way, as a function of the rotation of the tube 7 and the displacements of the door 100, the spring 127 exerts on this tube and on the ring 4 which is rigidly associated therewith, a torque C₁ which opposes the torque C₂ exerted on this same tube by the straps S₁ and S₂ due to the weight P of the door 100. C₃ denotes the sum of the torques C₁ and C₂.

As previously, a brake 8 is installed between the motor 5 and a reduction gear 9 which actuates the ring 4, this brake having the same function as that of the first embodiment and exerting a braking effort-which is variable as a function of the intensity and direction of the torque C₃.

The brake 8 may be of the same type as that of the first embodiment, or may be of different type.

In particular, as shown in broken lines in FIG. 8, a sensor 201 may be integrated in the mechanism 1 in the vicinity of the ring 4 in order to determine the direction of the torque C₃ and make it possible to know whether the door 100 is braking or driving. The electric output signal S₂₀₁ from the sensor 201 is then inputted to the brake 8, which makes it possible electrically to regulate the braking effort exerted by this brake 8 which is, in that case, advantageously of electromagnetic type.

The invention has been shown with a sectional door 100, but is applicable to any type of door, particularly garage doors with rigid frame with or without projection.

The invention has been shown with a brake of the type known from FR-A-2 834 391. However, it may be carried out with brakes such as those known from DE-C-909 274, DE-C-834 714, FR-A-2 720 806, IT-BO-92 U 000009 or from EP-A-1 326 000. Other brake structures may be envisaged within the framework of the present invention. In particular, the braking effort exerted by the brake is not necessarily a torque.

The technical characteristics of the different forms of embodiment described may be combined together within the framework of the invention.

1. Mechanism for manoeuvring a door with at least partially vertical movement, this mechanism comprising:
an electric motor;
a member adapted to be driven by the motor and kinematically linked with the door; and
means for compensating at least partially the torque exerted by the weight of the door on said member,
wherein it comprises a brake interposed between said motor and said member, and adapted to exert against said motor a braking effort at least in the phases of displacement of the door where the combined effect of the weight of the door and of the effort exerted by said compensation means tends to displace said member in the same direction as said motor.

2. The mechanism of claim 1, wherein said braking effort is maximum, when the combined effect of the weight of the door and of the effort exerted by the compensation means tends to displace said member in the same direction as said motor.

3. The mechanism of claim 1, wherein said braking effort is decreasing as a function of the combined effect of the weight of the door and of the effort exerted by the compensation means when said combined effect tends to displace said member in the opposite direction to said motor.

4. The mechanism of claim 3, wherein said braking effort is substantially inversely proportional to the combined effect of the weight of the door and of the effort exerted by the compensation means when said combined effect tends to displace said member in the opposite direction to said motor.

5. The mechanism of claim 1, wherein the maximum value of the braking torque exerted by the brake is substantially equal to the nominal torque of the motor.

6. The mechanism of claim 1, wherein the motor is of D.C. type, with a regulated voltage supply.

7. The mechanism of claim 1, wherein the brake is of friction type, with at least one mobile lining as a function of the value and/or the direction of the combined effect of the weight of the door and of the effort exerted by the compensation means.

8. The mechanism of claim 1, wherein it comprises a sensor for detecting the direction and/or the value of the combined effect of the weight of the door and of the effort exerted by the compensation means, said brake being controlled to exert said braking effort as a function of the output signal of said sensor.

9. Use of a brake adapted to exert a variable effort for regulating the torque that must be exerted by an electric motor for driving a member fast with a door with partially vertical movement subjected to the action of means for at least partially compensating its weight.

10. Method for regulating the torque to be exerted by an electric motor in a mechanism for manoeuvring a door with partially vertical movement where the weight of the door is at least partially compensated, wherein it comprises at least one step consisting in:
exerting against the motor a braking effort variable as a function of the intensity and the direction of the combined effect of the weight of the door and of the effort of compensation of said weight.

11. The method of claim 10, wherein the braking effort has a maximum value, when the combined effect of the weight of the door and of the effort of compensation of said weight tends to displace said member in the same direction as said motor.

12. The method of claim 10, wherein the braking effort has a decreasing value as a function of the combined effect of the weight of the door and of the effort of compensation of said weight when said combined effect tends to displace said member in the opposite direction to said motor.

13. The method of claim 12, wherein the braking effort has a value substantially inversely proportional to the combined effect of the weight of the door and of the effort of compensation of said weight when said combined effect tends to displace said member in the opposite direction to said motor.
